(19) United States
(12) Patent Application Publication
(10) Pub. No.: US 2022/0103620 A1
(43) Pub. Date: Mar. 31, 2022

(54) OPERATION MANAGEMENT SYSTEM AND OPERATION MANAGEMENT METHOD

(71) Applicant: Hitachi, Ltd., Tokyo (JP)

(72) Inventor: Akiho MIYAMURA, Tokyo (JP)

(73) Assignee: Hitachi, Ltd.

(21) Appl. No.: 17/200,433

(22) Filed: Mar. 12, 2021

(30) Foreign Application Priority Data
Sep. 30, 2020 (JP) 2020-165876

(51) Int. Cl. H04L 29/08

(52) U.S. Cl. CPC H04L 67/1031; H04L 67/12; H04L 67/101

(57) ABSTRACT

An operation management system capable of implementing optimum deployment of applications and data is provided. The operation management system is designed to include: a first edge server including a first storage unit which stores data acquired from a sensor; a second edge server including an application for processing the data; an information management unit that generates relation information, when the data stored in the first storage unit is processed by the application, by associating information indicating the data, information indicating the first storage unit which stores the data, information indicating the application, and information indicating the second edge server in which the application is provided, with each other, and an output unit that outputs the relation information generated by the information management unit.

### TECHNICAL FIELD

The present invention generally relates to a technology for managing the operation of edge servers.

### BACKGROUND ART

In recent years, much attention has been focused on edge computing in association with expansion of IoT (Internet of Things). According to the edge computing, edge servers to which sensors are coupled are dispersedly deployed at a site such as a factory and applications provided in the edge servers execute processing of data acquired by the sensors.

However, as the data continues to increase, deviation of loads on the edge servers may sometimes occur and/or the capacity of a storage apparatus may sometimes become crucially scarce.

Regarding this issue, there is disclosed a technology for suppressing the deviation of processing loads between a plurality of information processing apparatuses (see PTL 1).

### CITATION LIST

### Patent Literature

PTL 1: Japanese Patent Application Laid-Open (Kokai) Publication No. 2018-32079

### SUMMARY OF THE INVENTION

### Problems to be Solved by the Invention

The technology described in PTL 1 is targeted at only loads on disk I/O (Input/Output), so that the deviation of the loads on resources used by the applications provided in the edge servers may not sometimes be resolved.

The present invention was devised in consideration of the above-described circumstance and aims at proposing an operation management system or the like capable of implementing optimum deployment of the applications and data.

### Means to Solve the Problems

In order to solve the above-described problem, provided according to an aspect of the present invention is an operation management system including a plurality of edge servers and for managing operation of the plurality of edge servers, wherein the operation management system includes: a first edge server including a first storage unit which stores data acquired from a sensor; a second edge server including an application for processing the data; an information management unit that generates relation information, when the data stored in the first storage unit is processed by the application, by associating information indicating the data, information indicating the first storage unit which stores the data, information indicating the application, and information indicating the second edge server in which the application is provided, with each other, and an output unit that outputs the relation information generated by the information management unit.

Since the relation information is output in the above-described configuration, for example, it becomes possible to recognize the relationship between application(s) and data and manually or automatically deploy the application(s) and/or the data at the optimum edge server(s).

### Advantageous Effects of the Invention

The application(s) and data can be optimally deployed in the edge servers according to the present invention.

### BRIEF DESCRIPTION OF DRAWINGS

FIG. 1 is a diagram illustrating an example of a configuration relating to an operation management system according to a first embodiment;

FIG. 2 is a diagram illustrating an example of a hardware configuration relating to the operation management system according to the first embodiment;

FIG. 3 is a diagram illustrating an example of a functional configuration relating to the operation management system according to the first embodiment;

FIG. 4 is a diagram illustrating an example of relation information according to the first embodiment;

FIG. 5 is a diagram illustrating an example of a characteristic configuration of the operation management system according to the first embodiment;

FIG. 6 is a diagram illustrating an example of generation processing according to the first embodiment;

FIG. 7 is a diagram illustrating an example of processing relating to optimum deployment based on resource load according to the first embodiment;

FIG. 8 is a diagram illustrating an example of processing relating to optimum deployment based on I/O load according to the first embodiment;

FIG. 9 is a diagram illustrating an example of processing relating to deletion of unnecessary data according to the first embodiment;

FIG. 10 is a diagram illustrating an example of resource load detection processing according to the first embodiment;

FIG. 11 is a diagram illustrating an example of processing for selecting an application to be migrated according to the first embodiment;

FIG. 12 is a diagram illustrating an example of application migration destination candidate selection processing according to the first embodiment;

FIG. 13 is a diagram illustrating an example of application migration destination extraction processing according to the first embodiment;

FIG. 14 is a diagram illustrating an example of application and data migration destination deciding processing according to the first embodiment;

FIG. 15 is a diagram illustrating an example of candidate selection processing according to the first embodiment;

FIG. 16 is a diagram illustrating an example of migration processing according to the first embodiment;

FIG. 17 is a diagram illustrating an example of I/O load detection processing according to the first embodiment;

FIG. 18 is a diagram illustrating an example of processing for selecting data to be migrated according to the first embodiment;

FIG. 19 is a diagram illustrating an example of data migration destination candidate selection processing according to the first embodiment;

FIG. 20 is a diagram illustrating an example of data migration destination extraction processing according to the first embodiment;

FIG. 21 is a diagram illustrating an example of data and application migration destination deciding processing according to the first embodiment;

FIG. 22 is a diagram illustrating an example of period expiration deletion processing according to the first embodiment; and

FIG. 23 is a diagram illustrating an example of emergent deletion processing according to the first embodiment.

### DESCRIPTION OF EMBODIMENTS

### (1) First Embodiment

One embodiment of the present invention will be explained below in detail. However, the present invention is not limited to the embodiment.

An operation management system according to this embodiment stores the relation information indicating the relation between applications and data (for example, by creating a database). This operation management system, for example, deploys an application(s) and data at an optimum edge server(s) on the basis of the relation information so that processing performance of the edge servers will not degrade. Furthermore, for example, this operation management system: judges whether the data is unnecessary or not, on the basis of the relation information in order to prevent the storage capacity from becoming crucially scarce due to the data which keeps increasing; and automatically deletes the data which is judged as unnecessary.

Next, the embodiment of the present invention will be explained with reference to the drawings. The following description and the drawings illustrate examples in order to explain the present invention and some omissions and simplification are made as appropriate for the purpose of clarification of the explanation. The present invention can be implemented in other various forms. Unless specifically limited, each constituent element may be either singular or plural.

Incidentally, in the following explanation, the same number will be assigned to the same elements in the drawings and an explanation about them will be omitted as necessary. Furthermore, when explaining elements of the same type without distinguishing them each other, a common part (the part excluding a branch number) of the reference numeral including the branch number is used; and when explaining the elements of the same type by distinguishing them each other, the reference numerals including the branch numbers may sometimes be used. For example, when explaining edge servers without particularly distinguishing them each other, they will be described as “edge servers 120”; and when explaining the edge servers by individually distinguishing them each other, they may sometimes be described as an “edge server 120-1” and an “edge server 120-2.”

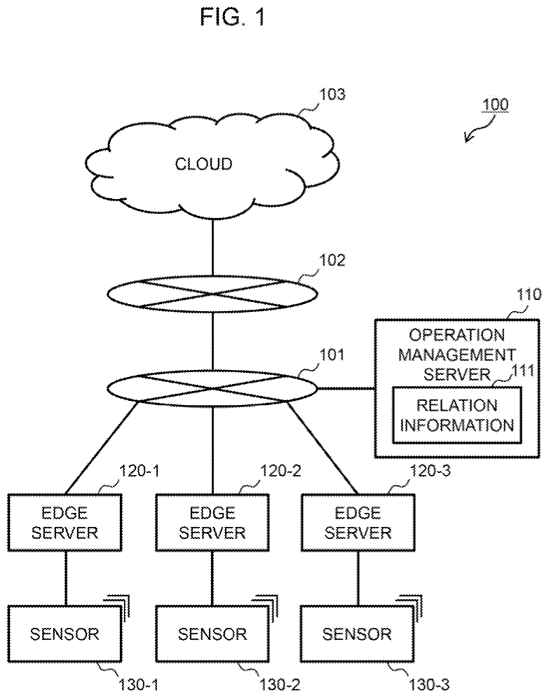

FIG. 1 is a diagram illustrating an example of the configuration relating to an operation management system 100.

The operation management system 100 is configured by including one or more operation management servers 110 and one or more edge servers 120. The operation management server(s) 110 and the edge server(s) 120 are computers in a limited space such as a factory. The operation management server(s) 110 and the edge server(s) 120 are coupled to each other via an internal network 101 so that they can communicate with each other. The internal network 101 performs communications by using private IP addresses.

The operation management server 110 is equipped with relation information 111. The relation information 111 is information indicating the relation between an application(s) provided in the edge server(s) 120 and data stored in the edge server(s) 120. The operation management server 110 manages the operation (environment) of the edge server(s) 120 on the basis of the relation information 111 so that the edge server(s) 120 can execute processing without causing the edge server(s) 120 to stop due to unexpected factors.

Under this circumstance, if the applications, data, and so on increase in the edge servers 120, deviation of resource loads, deviation of I/O loads, shortage of the storage capacity, and so on occur at every edge server 120. In order to solve them, the operation management server 110 issues an instruction to the relevant edge server 120 to migrate (deploy) an application in an edge server 120 with a high resource load to an edge server 120 with a low resource load or to migrate data of an edge server 120 with a high I/O load to an edge server 120 with a low I/O load. Furthermore, the operation management server 110 issues an instruction to the relevant edge server 120 to delete unnecessary data before the storage capacity becomes insufficient.

One or more sensors 130 are coupled to an edge server 120. However, there may be an edge server(s) 120 to which the sensor 130 is not coupled. The edge server 120 stores data received from the sensor 130 in a local storage apparatus (for example, a storage apparatus 223 described later). Furthermore, the edge server 120 executes various kinds of processing with respect to data in a specified storage apparatus (the local storage apparatus or an external storage apparatus) and stores data of the processing results in the specified storage apparatus. Incidentally, the edge server 120 sometimes transmits the data stored in the specified storage apparatus to a cloud 103 via the internal network 101 and an external network 102. The external network 102 performs communications by using global IP addresses.

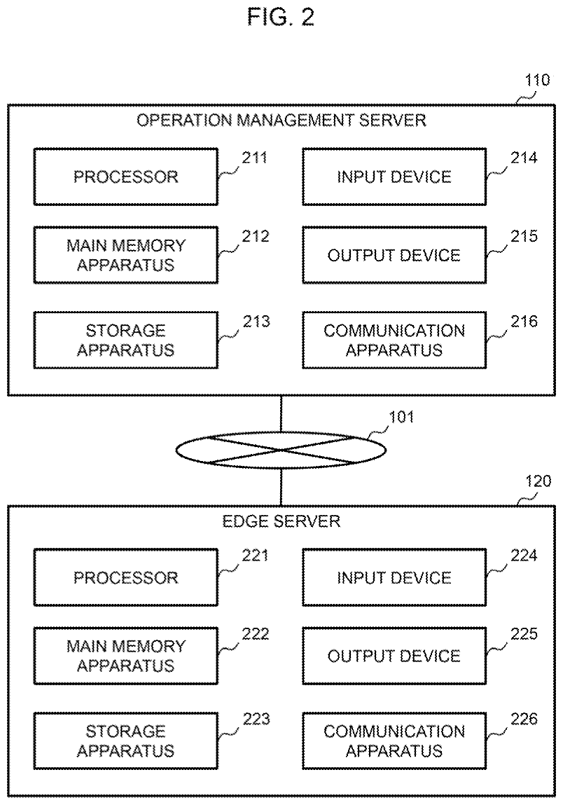

FIG. 2 is a diagram illustrating an example of a hardware configuration relating to the operation management system 100.

The operation management server 110 includes, as constituent elements, a processor 211, a main memory apparatus 212, a storage apparatus 213, an input device 214, an output device 215, and a communication apparatus 216.

The processor 211 is an apparatus for executing arithmetic operation processing. The processor 211 is, for example, a CPU (Central Processing Unit), an MPU (Micro Processing Unit), a GPU (Graphics Processing Unit), or an AI (Artificial Intelligence) chip.

The main memory apparatus 212 is an apparatus for storing programs, data, and so on. The main memory apparatus 212 is, for example, a ROM (Read Only Memory), a RAM (Random Access Memory), and so on. The ROM is an SRAM (Static Random Access Memory), an NVRAM (Non-Volatile RAM), a mask ROM (Mask Read Only Memory), a PROM (Programmable ROM), and so on. The RAM is a DRAM (Dynamic Random Access Memory) and so on.

The storage apparatus 213 is a hard disk drive, a flash memory, an SSD (Solid State Drive), an optical storage device, and so on. The optical storage device is a CD (Compact Disc), a DVD (Digital Versatile Disc), and so on. The programs, data, and so on which are stored in the storage apparatus 213 are read to the main memory apparatus 212 from time to time.

The input device 214 is a user interface which accepts information from a user. The input device 214 is, for example, a keyboard, a mouse, a card reader, and a touch panel.

The output device 215 is a user interface which outputs various kinds of information (such as display outputs, sound outputs, and print outputs). The output device 215 is, for example, a display device, a sound output device (a speaker), a printer, and so on for visualizing various kinds of information. The display device is, for example, an LCD (Liquid Crystal Display) and a graphic card.

The communication apparatus 216 is a communication interface for communicating with other apparatuses via a communication medium. The communication apparatus 216 is, for example, an NIC (Network Interface Card), a wireless communication module, a USB (Universal Serial Interface) module, and a serial communication module. The communication apparatus 216 can also function as an input device for receiving information from other apparatuses coupled thereto so that they can communicate with each other. Furthermore, the communication apparatus 216 can also function as an output device for transmitting information to other apparatuses coupled thereto so that they can communicate with each other.

The edge server 120 includes, as constituent elements, a processor 221, a main memory apparatus 222, a storage apparatus 223, an input device 224, an output device 225, and a communication apparatus 226.

Since the respective constituent elements of the edge server 120 are the same as the respective constituent elements of the operation management server 110, an explanation about them is omitted.

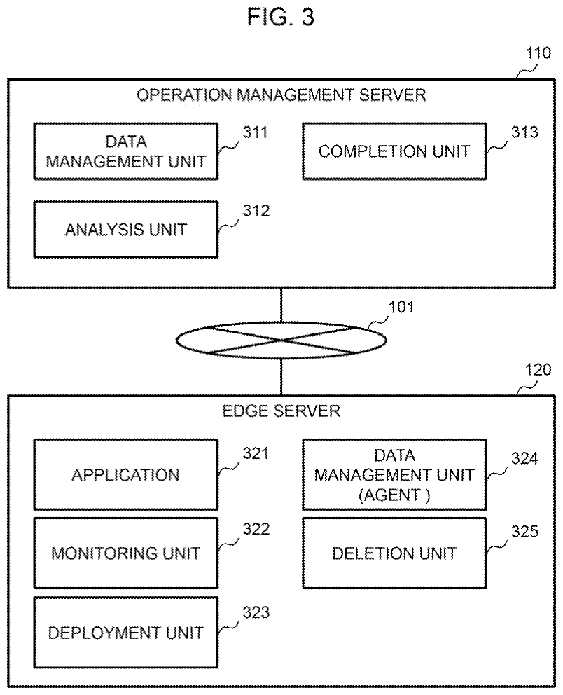

FIG. 3 is a diagram illustrating an example of a functional configuration relating to the operation management system 100.

Functions of the operation management server 110 (such as a data management unit 311, an analysis unit 312, and a completion unit 313) may be implemented by, for example, the processor 211 by reading programs stored in the storage apparatus 213 to the main memory apparatus 212 and executing the programs (software), may be implemented by hardware such as a dedicated circuit, or may be implemented by a combination of the software and the hardware.

Incidentally, one function of the operation management server 110 may be divided into a plurality of functions or the plurality of functions may be integrated into one function. Furthermore, part of a function of the operation management server 110 may be provided as another function or may be included in another function. Furthermore, part of a function of the operation management server 110 may be implemented by another computer which can communicate with the operation management server 110.

Functions of the edge server 120 (such as an application 321, a monitoring unit 322, a deployment unit 323, a data management unit 324, and a deletion unit 325) may be implemented by, for example, the processor 211 by reading programs stored in the storage apparatus 223 to the main memory apparatus 222 and executing the programs (software), may be implemented by hardware such as a dedicated circuit, or may be implemented by a combination of the software and the hardware.

Additionally, the application 321 is software such as a container and a VM (Virtual Machine). An explanation will be provided below about a case where a container is used as the application 321. Furthermore, the edge server 120 may not include the application 321 or may include a plurality of applications 321. Furthermore, the data management unit 324 is a function that operates as an agent of the data management unit 311.

Incidentally, one function of the edge server 120 may be divided into a plurality of functions or the plurality of functions may be integrated into one function. Furthermore, part of a function of the edge server 120 may be provided as another function or may be included in another function. Furthermore, part of a function of the edge server 120 may be implemented by another computer which can communicate with the edge server 120.

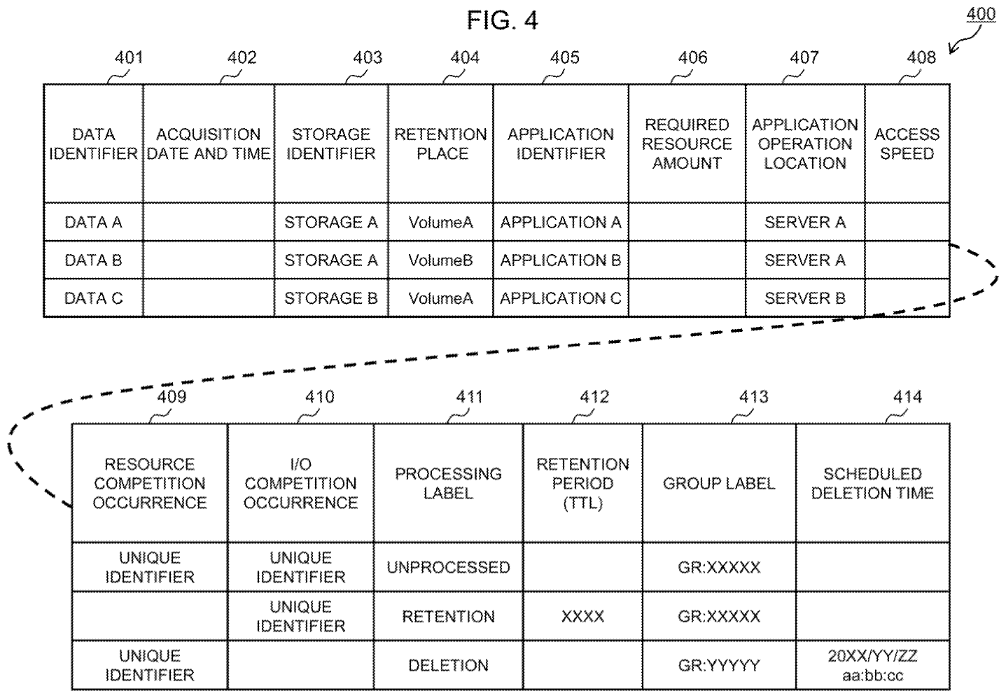

FIG. 4 is a diagram illustrating an example of the relation information 111 (a relation table 400). An explanation will be provided below by taking the relation table 400 as an example of the relation information 111.

The relation table 400 is configured by including information of a data identifier 401, an acquisition date and time 402, a storage identifier 403, a retention place 404, an application identifier 405, a required resource amount 406, an application operation location 407, an access speed 408, a resource competition occurrence 409, an I/O competition occurrence 410, a processing label 411, a retention period 412, a group label 413, and scheduled deletion time 414.

The data identifier 401 is information capable of identifying data in the operation management system 100. The acquisition date and time 402 is information indicating the date and time when the relevant data was acquired from the sensor 130 or the application 321. The storage identifier 403 is information (for example, a storage name) capable of identifying a physical area where the relevant data is stored (for example, the storage apparatus 223). The retention place 404 is information (for example, a volume name) capable of identifying a logical area where the relevant data is stored (for example, a volume). The application identifier 405 is information (for example, an application name) capable of identifying the application 321 which used the relevant data.

The required resource amount 406 is information (such as 1 Ghz or 2 GB) indicating a resource amount of resources required by the application 321 for processing the relevant data (a required resource amount). The resources are hardware resources of the edge server 120 and include the processor 221, the main memory apparatus 222, and so on. The application operation location 407 is information (for example, a server name) capable of identifying the location (for example, the edge server 120) where the application 321 which uses the relevant data operates. The access speed 408 is information indicating how fast the access to the relevant data is.

The resource competition occurrence 409 is information indicating a resource competition. The resource competition means that an amount of resources required by a plurality of applications 321 (a required resource amount) exceeds an amount of resources which can be supplied by the edge server 120 (a supplied amount). The I/O competition occurrence 410 is information indicating an I/O competition. The I/O competition means that the plurality of applications 321 access the same data at once (at the same time or almost at the same time) or the plurality of applications 321 demand I/O from the storage apparatus 223, so that the I/O load will be imposed more than the performance of the relevant storage apparatus 223 and access time will thereby become longer.

The processing label 411 is information indicating a label assigned according to processing of the relevant data. The retention period 412 is information indicating a period of time to retain the relevant data. Incidentally, the information of the retention period 412 decreases along with the elapse of time, so that it may sometimes be described as a remaining retention period. The group label 413 is information capable of identifying a group to which the relevant data belongs. The group is a data range used by a series of processing by one or a plurality of applications 321. For example, if a plurality of pieces of data are processed by one application 321, the relevant plurality of pieces of data belong to the same group. Furthermore, for example, if the plurality of pieces of data are processed by a plurality of applications 321, the relevant plurality of pieces of data belong to the same group. Incidentally, an explanation will be provided below by taking, as an example, a case where the plurality of pieces of data are processed by one application 321. The scheduled deletion time 414 is information indicating scheduled time when the relevant data will be deleted. In this example, time when the remaining retention period becomes “0” is set to the scheduled deletion time 414.

Incidentally, the configuration of the relation table 400 is not limited to the configuration in which the relation table 400 is provided in the operation management server 110, but may be a configuration in which the relation table 400 is provided in each edge server 120 and all the relation tables 400 are synchronized with each other.

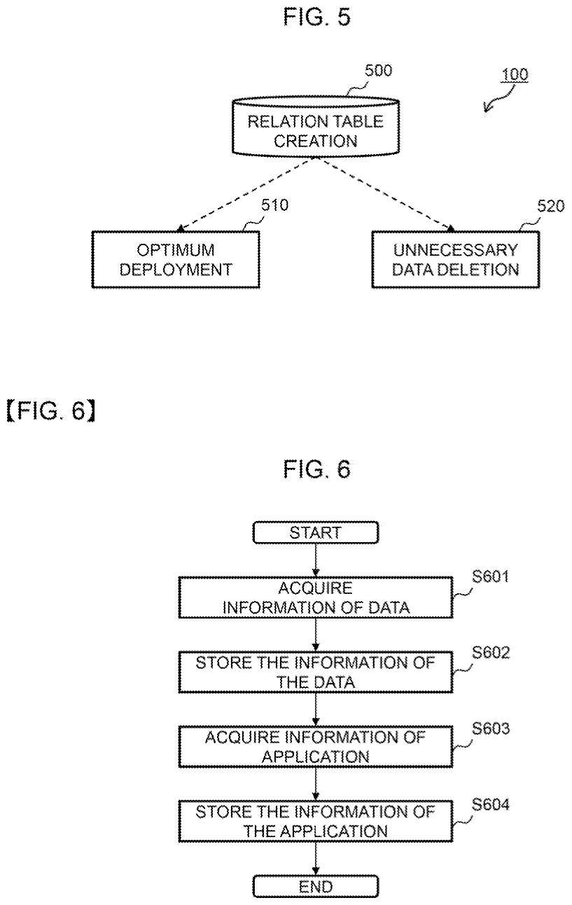

FIG. 5 is a diagram illustrating an example of a characteristic configuration of the operation management system 100.

The operation management system 100 generates and stores the relation table 400 (relation table creation 500). By using the relation table 400, applications 321 and data can be deployed at an optimum location(s) (optimum deployment 510) by a system administrator (manually) or the operation management server 110 and the edge server 120 (automatically). Furthermore, by using the relation table 400, unnecessary data can be deleted manually or automatically (unnecessary data deletion 520).

<Relation Table Creation 500>

The data management unit 311 stores, in the relation table 400, information indicating the relationship between data and applications 321, the relationship between the relevant data and the location where the relevant data is stored, and the relationship between the relevant application 321 and the location where the relevant application 321 operates.

<Optimum Deployment 510>

The monitoring unit 322 monitors the load (the resource load and the I/O load) on the edge servers 120. If the monitoring unit 322 detects that the load on the edge server 120 exceeds a threshold value, it transmits the detection of the excess beyond the threshold value (excess detection information) to the analysis unit 312. After receiving the excess detection information, the analysis unit 312 derives, on the basis of the relation table 400, an optimum edge server 120 for a migration target application 321 of the relevant edge server 120 and/or data to be used by the relevant application 321, so that the processing performance of the edge server 120 regarding which the excess beyond the threshold value has been detected will not degrade. The deployment unit 323 migrates the migration target application 321 and/or the data to be used by the relevant application 321 to the location decided by the analysis unit 312.

According to the above-described configuration, degradation of the processing performance of the application 321 and degradation of the access speed to the data can be further suppressed by deploying not only the application 321 or the data, but both the application 321 and the data to the optimum location.

<Unnecessary Data Deletion 520>

The data management unit 324 issues an instruction to the data management unit 324 to assign an unprocessed label to the data transmitted from the sensor 130. The data management unit 311 reflects, in the relation table 400, the assignment of the unprocessed label to the relevant data.

The completion unit 313 transmits the completion of the series of processing by the application 321 to the data management unit 311. The data management unit 311 reflects, in the relation table 400, the assignment of a retention label to the data used for the series of processing and reflects, in the relation table 400, the assignment of the unprocessed label to data generated by the series of processing. Furthermore, the data management unit 311 reflects, in the relation table 400, setting of the retention period (TTL) by assigning a group label to the relevant data.

Regarding data whose retention period has elapsed, the data management unit 311 updates the relation table 400 from the retention label to the deletion label.

If no access is made to data, to which the deletion label is assigned, within a specified amount of time (for example, 12 hours), the deletion unit 325 automatically deletes a data group to which the same group label is assigned as that of the relevant data. Incidentally, a default value of the specified amount of time is set as 12 hours, but the set value can be changed. Moreover, it is also possible to set data-type-based settings such as preprocessing data (data such as raw data received from the sensor 130 on which the processing has not been executed by the application 321) and processed data (data on which the processing has been executed by the application 321).

If the above-described configuration is employed, it is possible to avoid data processing errors attributable to the storage apparatus such as access errors, write errors, and so on due to the shortage of the storage capacity, implement stable operation, and reduce the operation cost by automatically deleting the unnecessary data and securing a free space.

If the operation management system 100 is employed, the edge servers 120 can be operated appropriately even if the applications 321 and the data increase or decrease.

FIG. 6 is a diagram illustrating an example of processing relating to the relation table creation 500 (generation processing). The generation processing is executed at specified timing. Incidentally, the specified timing may be in real time, periodically, at previously designated time, or at timing designated by the system administrator.

In S601, the data management unit 324 acquires data from the sensor 130. Incidentally, regarding the acquisition of the data, the sensor 130 may transmit the data at specified timing or the data management unit 324 may request the data from the sensor 130 and receive the relevant data.

Moreover, for example, in S601, the data management unit 324 stores the relevant data, together with a data identifier of the relevant data, in the storage apparatus 223. The data management unit 324 transmits information of the acquired data to the data management unit 311. The information of the relevant data includes, for example, the data identifier of the relevant data, the acquisition date and time of the relevant data, a storage name of the storage apparatus 223 in which the relevant data is stored, and a volume name of a volume in which the relevant data is stored.

In S602, the data management unit 311 stores the information of the data, which has been acquired by the data management unit 324, in the relation table 400.

In S603, the data management unit 324 acquires information of the application 321. For example, if the data stored in the storage apparatus 223 (the preprocessing data) is processed by the application 321 and data (processed data) is then newly generated and stored in the storage apparatus 223, the data management unit 324 acquires the information of the relevant preprocessing data and the information of the relevant processed data. The information of the relevant preprocessing data includes information of, for example, an application name of the application 321 for which the relevant preprocessing data was used, and a server name of the edge server 120 where the relevant application 321 operates. The information of the relevant processed data includes information of, for example, the data identifier of the relevant processed data, the acquisition date and time of the relevant processed data, the storage name of the storage apparatus 223 in which the relevant processed data is stored, and the volume name of the volume in which the relevant processed data is stored.

In S604, the data management unit 311 stores the information of the application 321, which is acquired from the data management unit 324, in the relation table 400.

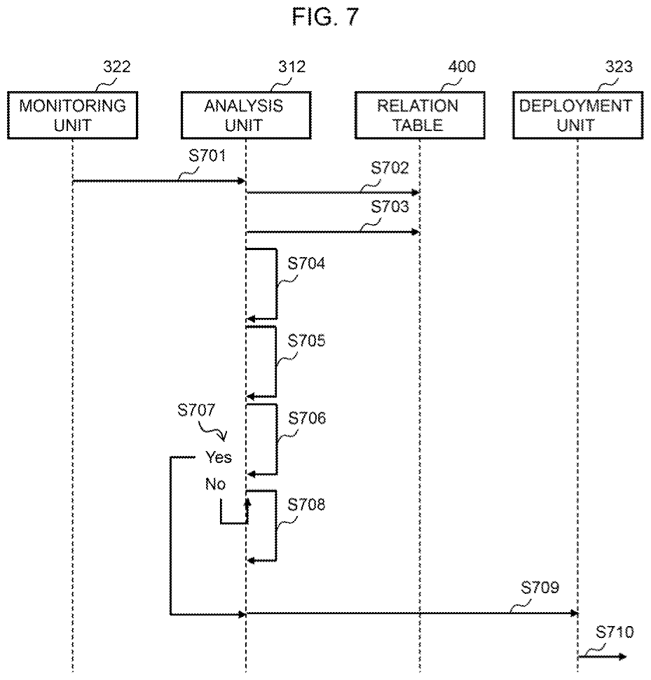

FIG. 7 to FIG. 9 illustrate an example of sequence diagrams of the optimum deployment 510 and the unnecessary data deletion 520.

FIG. 7 is a diagram illustrating an example of processing relating to the optimum deployment 510 based on the resource load.

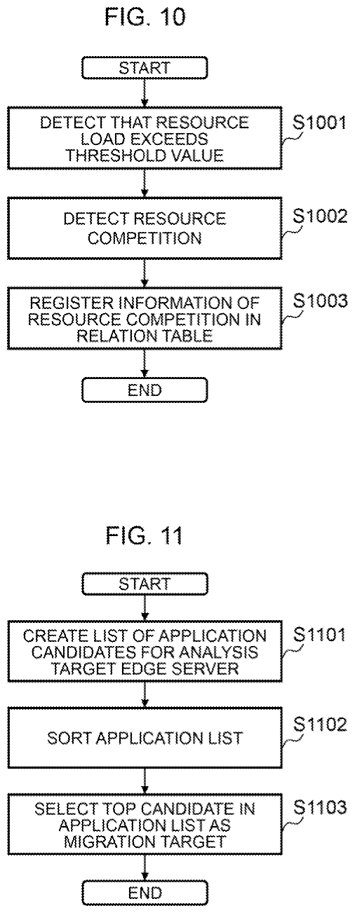

In S701, the monitoring unit 322 executes processing for detecting an excess of the resource load beyond a threshold value (resource load detection processing). If the monitoring unit 322 detects the excess of the resource load beyond the threshold value, it transmits the detection of the excess of the resource load beyond the threshold value to the analysis unit 312. Incidentally, the resource load detection processing will be described later with reference to FIG. 10.

In S702, with respect to data regarding which the resource competition has occurred, the analysis unit 312 registers information indicating the occurrence of the resource competition in the relation table 400 (the resource competition occurrence 409).

In S703, the analysis unit 312 reads the relation table 400.

In S704, the analysis unit 312 executes processing for selecting an application 321 to be migrated (processing for selecting an application to be migrated). Incidentally, the processing for selecting the application to be migrated will be described later with reference to FIG. 11.

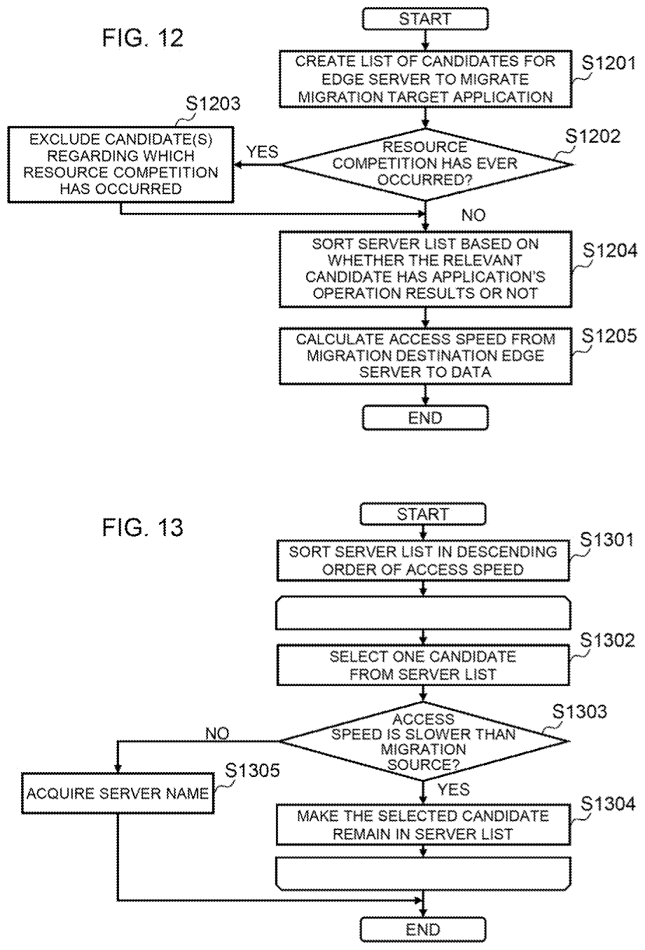

In S705, the analysis unit 312 executes processing for selecting a candidate for an edge server 120 (migration destination) to migrate the application 321 selected in S704 (application migration destination candidate selection processing). Incidentally, the application migration destination candidate selection processing will be described later with reference to FIG. 12.

In S706, the analysis unit 312 executes processing for extracting the migration destination of the application 321 from the migration destination candidate selected in S705 (application migration destination extraction processing). Incidentally, the application migration destination extraction processing will be described later with reference to FIG. 13.

In S707, the analysis unit 312 judges whether the migration destination of the application 321 has been extracted successfully or not. If the analysis unit 312 determines that the migration destination of the application 321 has been extracted successfully, the processing proceeds to S709; and if the analysis unit 312 determines that the migration destination of the application 321 has not been extracted successfully, the processing proceeds to S708. Additionally, if the analysis unit 312 determines that the optimum deployment will be achieved only by migrating the application 321, the processing proceeds to S709; and if the analysis unit 312 determines that the optimum deployment will be achieved by migrating the application 321 and migrating the data, the processing proceeds to S708.

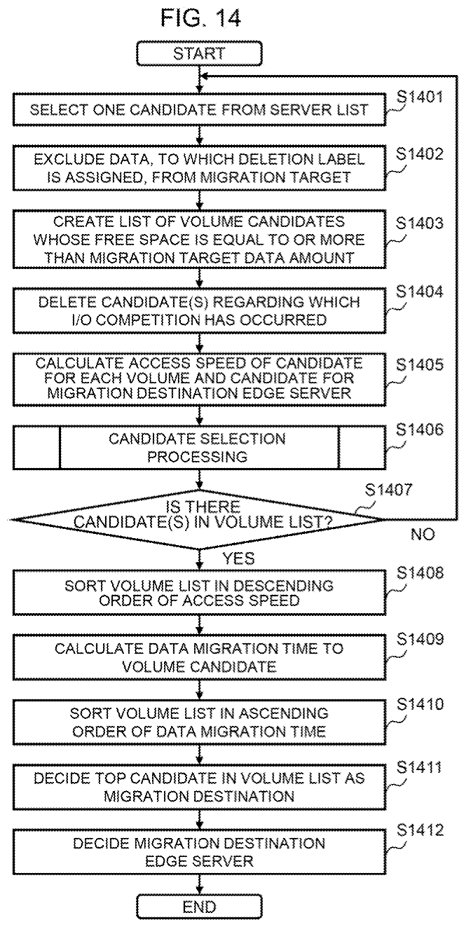

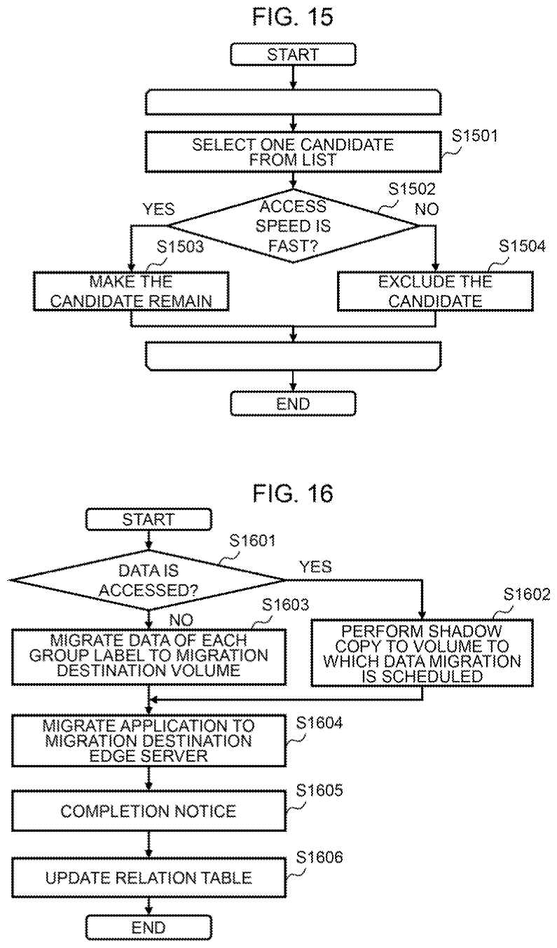

In S708, the analysis unit 312 executes processing for deciding an optimum migration destination(s) for the application 321 selected in S704 and the data to be used by that application 321 (application and data migration destination deciding processing). Incidentally, the application and data migration destination deciding processing will be described later with reference to FIG. 14 and FIG. 15.

In S709, the analysis unit 312 transmits information of the migration destination of the application 321 selected in S704 or information of the migration destination, which is decided in S708, of the relevant application 321 and the data to be used by the relevant application 321 to the deployment unit 323.

In S710, the deployment unit 323 executes processing for migrating the application 321 selected in S704 or the relevant application 321 and the data to be used by the relevant application 321 as decided in S708 (migration processing) on the basis of the received information of the migration destination. Incidentally, the migration processing will be described later with reference to FIG. 16.

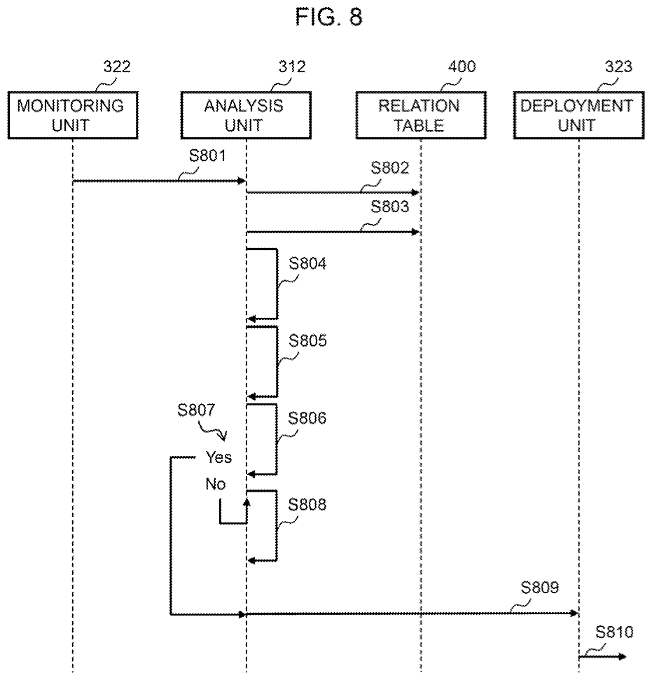

FIG. 8 is a diagram illustrating an example of processing relating to the optimum deployment 510 based on the I/O load.

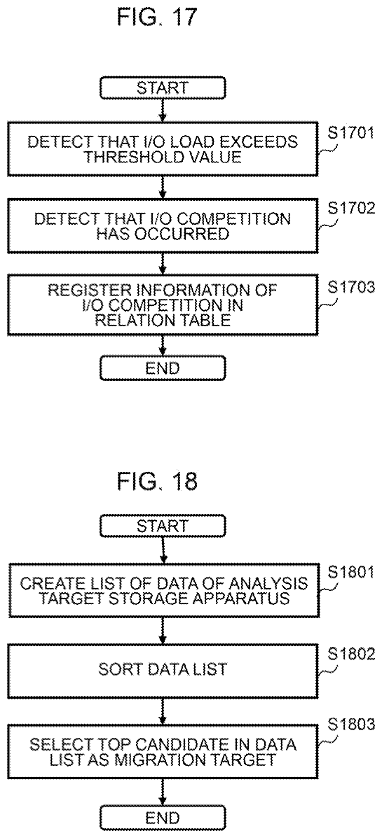

In S801, the monitoring unit 322 executes processing for detecting an excess of the I/O load beyond a threshold value (I/O load detection processing). If the monitoring unit 322 detects the excess of the I/O load beyond the threshold value, it transmits the detection of the excess of the I/O load beyond the threshold value to the analysis unit 312. Incidentally, the I/O load detection processing will be described later with reference to FIG. 17.

In S802, with respect to data regarding which the I/O competition has occurred, the analysis unit 312 registers information indicating the occurrence of the I/O competition in the relation table 400 (the I/O competition occurrence 410).

In S803, the analysis unit 312 reads the relation table 400.

In S804, the analysis unit 312 executes processing for selecting data to be migrated (processing for selecting data to be migrated). Incidentally, the processing for selecting the data to be migrated will be described later with reference to FIG. 18.

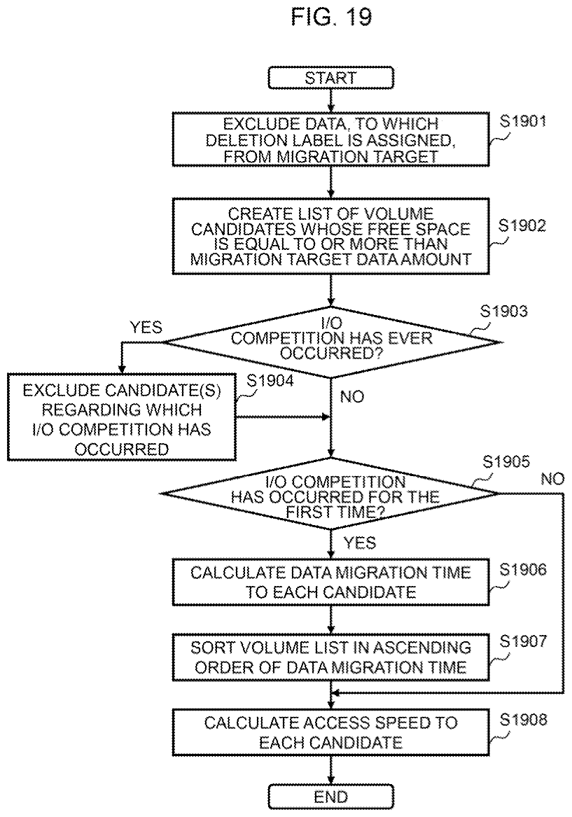

In S805, the analysis unit 312 executes processing for selecting a candidate for a volume (migration destination) to migrate the data selected in S804 (data migration destination candidate selection processing). Incidentally, the data migration destination candidate selection processing will be described later with reference to FIG. 19.

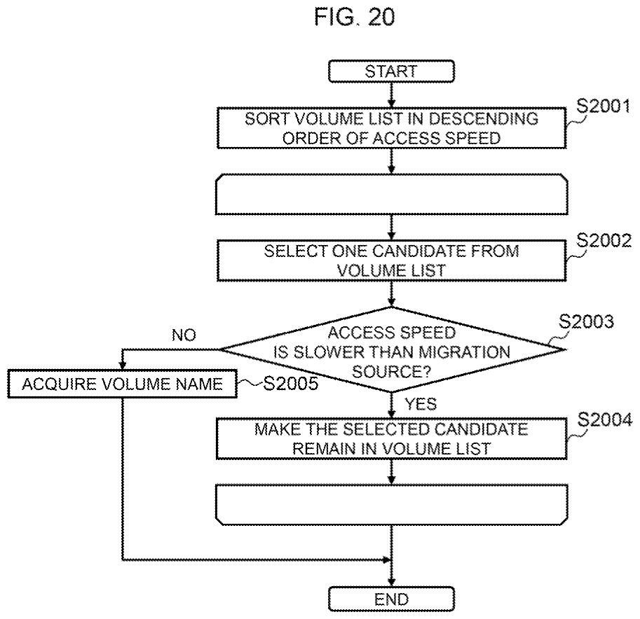

In S806, the analysis unit 312 executes processing for extracting the migration destination of the data from the migration destination candidate selected in S805 (data migration destination extraction processing). Incidentally, the data migration destination extraction processing will be described later with reference to FIG. 20.

In S807, the analysis unit 312 judges whether the migration destination of the data has been extracted successfully or not. If the analysis unit 312 determines that the migration destination of the data has been extracted successfully, the processing proceeds to S809; and if the analysis unit 312 determines that the migration destination of the data has not been extracted successfully, the processing proceeds to S808. Additionally, if the analysis unit 312 determines that the optimum deployment will be achieved only by migrating the data, the processing proceeds to S809; and if the analysis unit 312 determines that the optimum deployment will be achieved by migrating the data and migrating the application 321, the processing proceeds to S808.

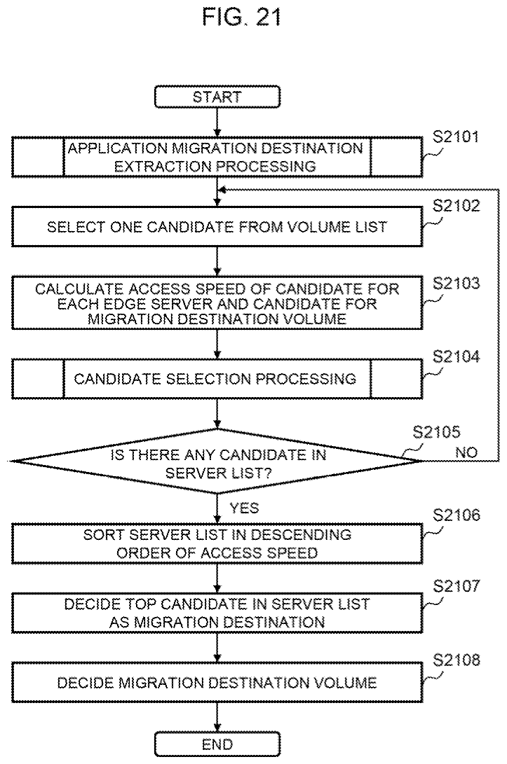

In S808, the analysis unit 312 executes processing for deciding an optimum migration destination(s) for the data selected in S804 and the application 321 to use that data (data and application migration destination deciding processing). Incidentally, the data and application migration destination deciding processing will be described later with reference to, for example, FIG. 21.

In S809, the analysis unit 312 transmits information of the migration destination of the data selected in S804 or information of the migration destination(s), which is decided in S808, of the relevant data and the application 321 to use the relevant data to the deployment unit 323.

In S810, the deployment unit 323 executes processing for migrating the information of the migration destination of the data selected in S804 or the relevant data and the application 321 to use that data as decided in S808 (migration processing) on the basis of the received information of the migration destination. Incidentally, the migration processing will be described later with reference to FIG. 16.

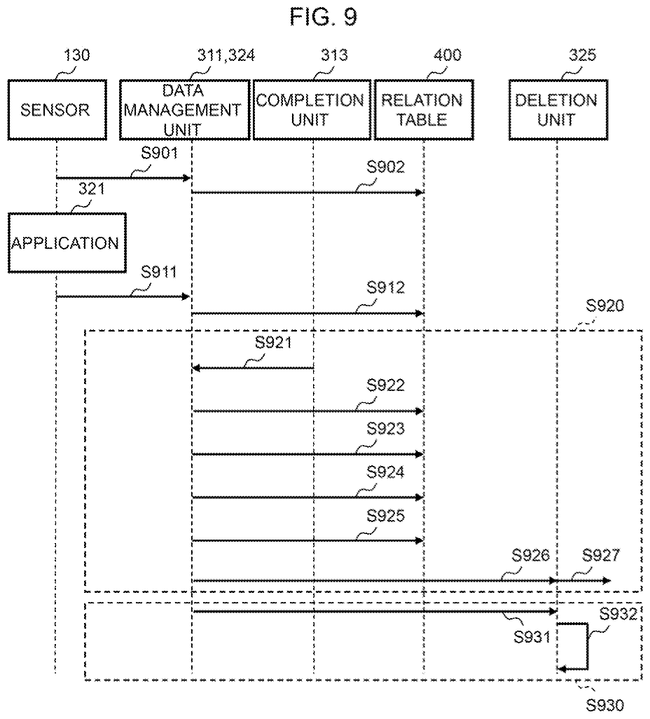

FIG. 9 is a diagram illustrating an example of processing relating to the unnecessary data deletion 520.

In S901, the sensor 130 transmits the measured (acquired) data to the data management unit 324.

In S902, the data management unit 324 issues an instruction to the data management unit 311 to assign the unprocessed label to the received data and the data management unit 311 registers information indicating the assignment of the unprocessed label to the relevant data, in the relation table 400 (the processing label 411).

In S911, the application 321 transmits the preprocessing data which is the data stored in the storage apparatus 223, and the processed data which is the data obtained by processing the relevant preprocessing data, to the data management unit 324.

In S912, the data management unit 324 issues an instruction to the data management unit 311 to assign the processing label to the preprocessing data and issues an instruction to the data management unit 311 to assign the unprocessed label to the processed data. The data management unit 311 registers information indicating the assignment of the processing label to the preprocessing data and information indicating the assignment of the unprocessed label to the processed data, in the relation table 400 (the processing label 411).

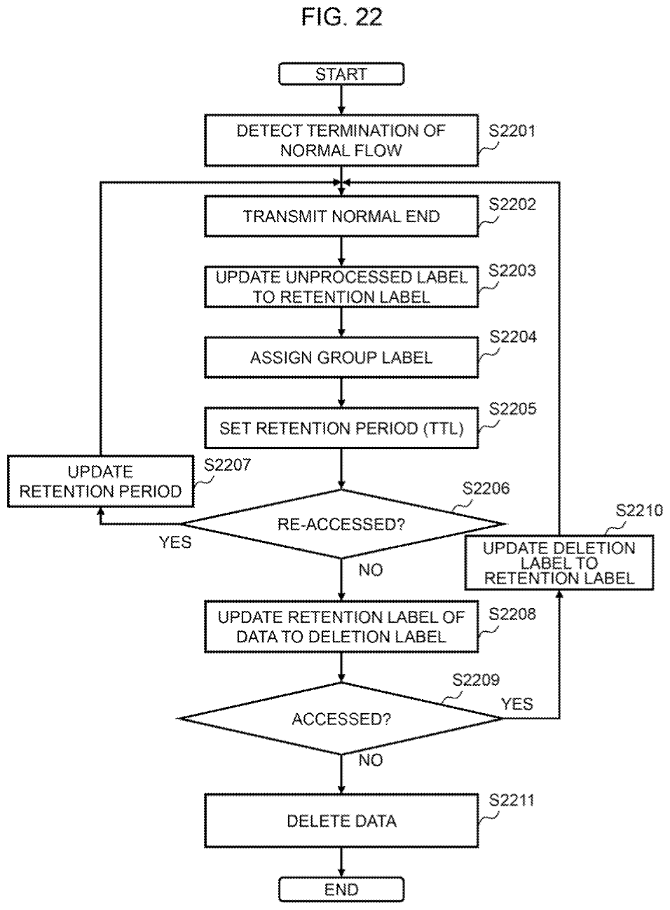

In S920, period expiration deletion processing is executed. The period expiration deletion processing will be explained with reference to S921 to S927 and FIG. 22.

In S921, the completion unit 313 transmits the completion of a series of processing by the application 321 (for example, a data identifier of data relating to the series of processing) to the data management unit 311.

In S922, the data management unit 311 registers information indicating the assignment of the retention label to the data with the received data identifier, in the relation table 400 (the processing label 411).

In S923, the data management unit 311 registers information indicating the assignment of the group label to the data with the received data identifier, in the relation table 400 (the group label 413).

In S924, the data management unit 311 registers information indicating setting of the retention period to the data with the received data identifier, in the relation table 400 (the retention period 412).

In S925, the data management unit 311 registers information indicating the assignment of the deletion label to the data whose retention period has elapsed, in the relation table 400 (the processing label 411).

In S926, the data management unit 311 detects data regarding which a specified amount of time has elapsed, among the data to which the deletion label is assigned, and issues an instruction to the deletion unit 325 to delete the detected data.

In S927, the deletion unit 325 deletes the data regarding which the specified amount of time has elapsed, among the data to which the deletion label is assigned, from the storage apparatus 223.

In S930, emergent deletion processing is executed. The emergent deletion processing will be explained with reference to S931, S932, and FIG. 22.

In S931, the data management unit 311, 324 selects data to be deleted emergently and issues an instruction to the deletion unit 325 to delete the selected data.

In S932, the deletion unit 325 deletes the data, which is to be deleted emergently, from the storage apparatus 223.

FIG. 10 is a diagram illustrating an example of resource load detection processing.

In S1001, the monitoring unit 322 detects an excess of the resource load beyond a threshold value. For example, if the monitoring unit 322 detects that the required resource amount of the application 321 exceeds a resource amount of resources which can be supplied by the edge server 120 (resource supply amount), it transmits the detected result to the analysis unit 312.

In S1002, if the monitoring unit 322 detects that the resource load exceeds the threshold value, it detects whether the resource competition has occurred or not. If the monitoring unit 322 detects that the resource competition has occurred, it transmits information of the resource competition to the analysis unit 312. The information of the resource competition includes, for example, an application name of an application 321 relating to the resource competition and a data identifier of data used by the relevant application 321.

In S1003, the analysis unit 312 registers a unique character string in the resource competition occurrence 409 of the relation table 400 with respect to each piece of the data relating to the resource competition. Incidentally, the information of the resource competition may be registered in the relation table 400 by the data management unit 311, 324.

FIG. 11 is a diagram illustrating an example of the processing for selecting the application to be migrated.

In S1101, the analysis unit 312 creates a list of candidates for an application 321 included by an analysis target edge server 120 (generates an application list). Incidentally, the analysis target edge server 120 is the edge server 120 regarding which the resource load in excess of the threshold value was detected.

In S1102, the analysis unit 312 sorts (rearranges) the candidates in the application list. For example, the analysis unit 312 sorts the candidates in descending order of the required resource amount; and if there are the candidates with the same required resource amount, the candidates are sorted in ascending order of the I/O.

In S1103, the analysis unit 312 selects the candidate at the top of the application list as a migration target.

Accordingly, by selecting the application 321 with the largest required resource amount as the migration target and migrating it, it becomes possible to avoid the situation where the excess of the resource load on the analysis target edge server 120 beyond the threshold value occurs easily. Moreover, by selecting the application 321 with the small I/O as the migration target, it becomes possible to avoid the situation where the I/O by the relevant application 321 often occurs so that the relevant application 321 cannot be migrated.

FIG. 12 is a diagram illustrating an example of the application migration destination candidate selection processing.

In S1201, the analysis unit 312 creates a list of candidates for an edge server 120 (migration destination) to migrate the migration target application 321. For example, the analysis unit 312 selects an edge server 120 which has an amount of free resources (free resource amount) equal to or more than the required resource amount of the migration target application 321 as the candidate for the migration destination. Incidentally, the migration target application 321 is the application 321 selected in S1103.

In S1202, the analysis unit 312 refers to the relation table 400 and judges whether or not the migration target application 321 has ever experienced the resource competition with the applications 321 which operate in the respective candidate edge servers 120. If the analysis unit 312 determines that the resource competition has occurred, the processing proceeds to S1203; and if the analysis unit 312 determines that the resource competition has never occurred, the processing proceeds to S1204.

In S1203, the analysis unit 312 excludes the candidates regarding which the resource competition has occurred, from the server list.

In S1204, the analysis unit 312 sorts the candidates in the server list on the basis of whether they have operation results of the migration target application 321 or not. For example, the analysis unit 312 sorts the candidates, in which the relevant application 321 has ever operated at least once, to higher positions in the list and sorts the candidates, in which the relevant application 321 has never operated, to lower positions in the list.

In S1205, the analysis unit 312 calculates an access speed from the migration destination edge server 120 to the data (data to be used by the migration target application 321). For example, the analysis unit 312 calculates the access speed from the capacity of the data and a network bandwidth.

FIG. 13 is a diagram illustrating an example of the application migration destination extraction processing.

Under this circumstance, two cases, that is, one versus one or one versus many can be assumed regarding the correspondence relationship between the application 321 and the data.

In the case of one versus one, an access speed from the edge server 120 where the application 321 is provided is compared with an access speed from the edge server 120 which is the migration destination of the application 321; and if the access speed becomes faster than, or equivalent to, the current state, the application 321 is migrated.

In the case of one versus many, the application 321 may be migrated by judging only the access speed to one piece of data; and the application 321 may be deployed again on the basis of information updated by the monitoring unit 322. Moreover, by calculating all patterns of access speeds to the respective pieces of data from the edge server 120 which is the migration destination of the application 321, the application 321 may be migrated: if all the access speeds become faster; or if a majority of the access speeds become faster.

In S1301, the analysis unit 312 sorts the candidates in the server list in descending order of the access speed. Then, the analysis unit 312 repeats processing of S1302 to S1304 until it finds a candidate whose access speed is faster than that of the migration source or until it completes the comparison of all the candidates.

In S1302, the analysis unit 312 selects one unprocessed candidate from the server list.

In S1303, the analysis unit 312 judges whether the access speed from the selected candidate is slower than the access speed from the migration source or not. If the analysis unit 312 determines that the access speed from the selected candidate is slower than the access speed from the migration source, the processing proceeds to S1304; and if the analysis unit 312 determines that the access speed from the selected candidate is not slower than the access speed from the migration source (if the analysis unit 312 determines that the access speed from the selected candidate is faster than, or equivalent to, the access speed from the migration source), the processing proceeds to S1305.

In S1304, the analysis unit 312 leaves the candidate selected in S1302 in the server list and proceeds to the processing of S1302. Incidentally, if the candidate is left in the server list, the processing in FIG. 14 is subsequently executed.

In S1305, the analysis unit 312 extracts (acquires) the server name of the edge server 120, whose access speed is judged as faster than or equivalent to that of the migration source, as the migration destination. Incidentally, if the server name is acquired, the migration processing in FIG. 16 is subsequently executed.

FIG. 14 is a diagram illustrating an example of the application and data migration destination deciding processing.

In S1401, the analysis unit 312 selects one unprocessed candidate from the server list.

In S1402, the analysis unit 312 excludes data to which the deletion label is assigned, among the migration target data, from a migration target. Incidentally, the migration target data is data used by the migration target application 321.

In S1403, the analysis unit 312 creates a list of candidates for a volume whose free space is equal to or more than the capacity of the migration target data, among volumes provided in the operation management system 100 (generates a volume list).

In S1404, the analysis unit 312 deletes a candidate(s) regarding which the I/O competition has ever occurred, from the volume list.

In S1405, the analysis unit 312 calculates access speeds to data in the candidates for each volume and the candidates for the migration destination edge server 120. For example, the analysis unit 312 calculates the access speeds from the capacity of the data and the network bandwidth.

In S1406, the analysis unit 312 executes candidate selection processing. The candidate selection processing selects a volume candidate whose access speed to the data is faster than the access speed of the migration source volume. The candidate selection processing will be described later with reference to FIG. 15.

In S1407, the analysis unit 312 judges whether there is a candidate(s) in the volume list or not. If the analysis unit 312 determines that there is the candidate(s) in the volume list, the processing proceeds to S1408; and if the analysis unit 312 determines that there is no candidate in the volume list, the processing proceeds to S1401.

In S1408, the analysis unit 312 sorts the candidates in the volume list in descending order of the access speed.

In S1409, the analysis unit 312 calculates data migration time required to migrate data to each volume candidate. For example, the analysis unit 312 calculates the data migration time required to migrate the data to each volume candidate from the capacity of the data and the network bandwidth.

In S1410, the analysis unit 312 sorts the candidates in the volume list in ascending order of the data migration time.

In S1411, the analysis unit 312 decides the candidate at the top of the volume list as the migration destination.

In S1412, the analysis unit 312 decides the candidate for the edge server 120, which is the candidate judged as existing in the volume list in S1407, as the migration destination.

FIG. 15 is a diagram illustrating an example of the candidate selection processing. The analysis unit 312 executes processing of S1501 to S1504 on all candidates in the list (the volume list or the server list). Incidentally, the above-mentioned list in the candidate selection processing evoked from S1406 is the volume list and the above-mentioned list in the candidate selection processing evoked from S2104 is the server list.

In S1501, the analysis unit 312 selects one unprocessed candidate from the bet.

In S1502, the analysis unit 312 judges whether the access speed of the migration destination candidate selected in S1501 is faster than the access speed of the migration source or not. If the analysis unit 312 determines that the access speed of the migration destination candidate selected in S1501 is faster than the access speed of the migration source (new access speed>≈former access speed), the processing proceeds to S1503; and if the analysis unit 312 determines that the access speed of the migration destination candidate selected in S1501 is not faster than the access speed of the migration source, the processing proceeds to S1504.

In S1503, the analysis unit 312 leaves the candidate selected in S1501 in the list and proceeds to the processing of S1501.

In S1504, the analysis unit 312 excludes the candidate selected in S1501 from the list and proceeds to the processing of S1501.

FIG. 16 is a diagram illustrating an example of the migration processing.

In S1601, the deployment unit 323 judges whether the migration target data is accessed or not. If the deployment unit 323 determines that the migration target data is accessed, the processing proceeds to S1602; and if the deployment unit 323 determines that the migration target data is not accessed, the processing proceeds to S1603.

In S1602, the deployment unit 323 makes a shadow copy of the migration target data to the volume to which migration is scheduled. When the migration target data in the migration source storage apparatus 223 is no longer accessed, the deployment unit 323 deletes the migration target data.

In S1603, the deployment unit 323 migrates the migration target data (for example, data of each group label) to the migration destination volume.

In S1604, the deployment unit 323 migrates the migration target application 321 to the migration destination edge server 120.

In S1605, the deployment unit 323 transmits the completion of the migration to the analysis unit 312.

In S1605, the data management unit 311, 324 updates the relation table 400 (such as the storage identifier 403, the retention place 404, and the application operation location 407) to the migration destination.

FIG. 17 is a diagram illustrating an example of the I/O load detection processing.

In S1701, the monitoring unit 322 detects an excess of the I/O load beyond a threshold value. For example, if the monitoring unit 322 detects that the IOPS (Input/Output Per Second) becomes lower than a specified value, it transmits the detected result to the analysis unit 312.

In S1702, if the monitoring unit 322 detects that the I/O load exceeds the threshold value, it detects whether the I/O competition has occurred or not. If the monitoring unit 322 detects that the I/O competition has occurred, it transmits information of the I/O competition to the analysis unit 312. The information of the I/O competition includes, for example, the application name of an application 321 relating to the I/O competition and the data identifier of the data used by the relevant application 321.

In S1703, the analysis unit 312 registers a unique character string in the I/O competition occurrence 410 of the relation table 400 with respect to each application 321 regarding which the I/O competition occurred. Incidentally, the information of the I/O competition may be registered in the relation table 400 by the data management unit 311, 324.

FIG. 18 is a diagram illustrating an example of the processing for selecting the data to be migrated.

In S1801, the analysis unit 312 creates a list of data of an analysis target storage apparatus 223 (generates a data list). The analysis target storage apparatus 223 is the storage apparatus 223 regarding which the I/O load in excess of the threshold value was detected.

In S1802, the analysis unit 312 sorts the candidates in the data list. For example, the analysis unit 312 sorts the candidates in ascending order of the I/O; and if there are the candidates with the same I/O, the candidates are sorted in ascending order of the data capacity.

In S1803, the analysis unit 312 selects the data at the top of the data list as a migration target. Under this circumstance, the analysis unit 312 selects all pieces of data used by the application 321 related to the selected data or data to which the same group label as that of the selected data is assigned is selected as the migration target data.

Accordingly, by selecting the data with the small I/O as the migration target, it becomes possible to avoid the situation where the I/O to the relevant data frequently occurs and the relevant data cannot thereby be migrated. Moreover, by selecting the data with the small data capacity as the migration target, it becomes possible to shorten time required to migrate the relevant data.

FIG. 19 is a diagram illustrating an example of the data migration destination candidate selection processing.

In S1901, the analysis unit 312 excludes data to which the deletion label is assigned, from the migration target data.

In S1902, the analysis unit 312 creates a list of volumes whose free space is equal to or more than the migration target data amount, as migration destination candidates (generates a volume list).

In S1903, the analysis unit 312 refers to the relation table 400 and judges whether or not the I/O competition has ever occurred between the data stored in the volume candidate and the migration target data. If the analysis unit 312 determines that the I/O competition has occurred, the processing proceeds to S1904; and if the analysis unit 312 determines that the I/O competition has not occurred, the processing proceeds to S1905.

In S1904, the analysis unit 312 excludes the candidate(s) regarding which the I/O competition has occurred, from the volume list.

In S1905, the analysis unit 312 judges whether the I/O competition has occurred for the first time or not. If the analysis unit 312 determines that the I/O competition has occurred for the first time, the processing proceeds to S1906; and if the analysis unit 312 determines that the I/O competition has occurred not for the first time, the processing proceeds to S1908. Incidentally, although illustration in a drawing is omitted, the data management unit 311 stores information indicating the number of times the I/O competition has occurred (for example, history information).

In S1906, the analysis unit 312 calculates the data migration time required to migrate the data to each candidate. For example, the analysis unit 312 calculates the data migration time to migrate the data to each candidate from the capacity of the data and the network bandwidth.

In S1907, the analysis unit 312 sorts the candidates in the volume list in ascending order of the data migration time.

In S1908, the analysis unit 312 calculates the access speed to each candidate. For example, the analysis unit 312 calculates the access speed to each candidate from the capacity of the data and the network bandwidth.

FIG. 20 is a diagram illustrating an example of the data migration destination extraction processing.

Under this circumstance, two cases, that is, one versus one or one versus many can be assumed regarding the correspondence relationship between the data and the application(s) 321.

In the case of one versus one, an access speed from the edge server 120, which includes the application 321 using the data, to the migration source data is compared with an access speed from the relevant edge server 120 to the migration destination data; and if the access speed becomes faster than, or equivalent to, the current state, the data is migrated.

In the case of one versus many, the data may be migrated by judging only the access speed to one application 321; and the data may be deployed again on the basis of information updated by the monitoring unit 322. Moreover, by calculating all patterns of access speeds to the data from the edge servers 120 in which the respective applications 321 are provided, the data may be migrated: if all the access speeds become faster, or if a majority of the access speeds become faster.

In S2001, the analysis unit 312 sorts the candidates in the volume list in descending order of the access speed. Then, the analysis unit 312 repeats processing of S2002 to S2004 until it finds a candidate whose access speed is faster than that of the migration source or until it completes the comparison of all the candidates.

In S2002, the analysis unit 312 selects one unprocessed candidate from the volume list.

In S2003, the analysis unit 312 judges whether the access speed of the candidate selected in S2002 is slower than the access speed of the migration source or not. If the analysis unit 312 determines that the access speed of the selected candidate is slower than the access speed of the migration source, the processing proceeds to S2004; and if the analysis unit 312 determines that the access speed of the selected candidate is not slower than the access speed of the migration source (if the analysis unit 312 determines that the access speed of the selected candidate is faster than, or equivalent to, the access speed of the migration source), the processing proceeds to S2005.

In S2004, the analysis unit 312 leaves the candidate selected in S2002 in the volume list and proceeds to the processing of S2002. Incidentally, if the candidate is left in the volume list, the processing in FIG. 21 is subsequently executed.

In S2005, the analysis unit 312 extracts (acquires) the volume name of the volume, whose access speed is judged as faster than or equivalent to that of the migration source, as the migration destination. Incidentally, if the volume name is acquired, the migration processing in FIG. 16 is subsequently executed.

FIG. 21 is a diagram illustrating an example of the data and application migration destination deciding processing.

In S2101, the analysis unit 312 creates a list of candidates for the edge server 120 to which the application 321 to use the migration target data can be migrated (generates a server list) and executes the application migration destination extraction processing.

In S2102, the analysis unit 312 selects one unprocessed volume candidate from the volume list.

In S2103, the analysis unit 312 calculates access speeds to data in the candidates for the respective edge servers 120 and in the candidates for the migration destination volume. For example, the analysis unit 312 calculates the access speeds from the capacity of the data and the network bandwidth.

In S2104, the analysis unit 312 executes the candidate selection processing.

In S2105, the analysis unit 312 judges whether there is a candidate(s) in the server list or not. If the analysis unit 312 determines that there is a candidate(s) in the server list, the processing proceeds to S2106; and if the analysis unit 312 determines that them is no candidate in the server list, the processing proceeds to S2102.

In S2106, the analysis unit 312 sorts candidates in the server list in descending order of the access speed.

In S2107, the analysis unit 312 decides the candidate at the top of the server list as the migration destination.

In S2108, the analysis unit 312 decides the candidate for the volume, which is the volume judged as existing in the server list in S2105, as the migration destination.

FIG. 22 is a diagram illustrating an example of the period expiration deletion processing.

In S2201, the completion unit 313 detects the termination in a normal flow (normal end). The normal flow is, for example, a flow in which a plurality of pieces of data are processed by the application 321, or a flow in which the data is processed by the application 321 and the processed data is transmitted to the cloud 103.

In S2202, the completion unit 313 transmits information detecting the normal end to the data management unit 311. The information detecting the normal end includes the application name of an application 321 which executed the processing in the normal flow and the data identifier of data used by the relevant application 321 (data used in the normal flow).

In S2203, the data management unit 311 updates an unprocessed label of the data used in the normal flow (data group) to a retention label.

In S2204, the data management unit 311 assigns a unique group label to the data used in the normal flow (data group).

In S2205, the data management unit 311 sets a retention period (TTL) to the data used in the normal flow (data group).

In S2206, the data management unit 311, 324 judges whether or not the data to which the retention label is assigned is re-accessed before the expiration of the retention period. If the data management unit 311, 324 determines that the data is re-accessed, the processing proceeds to S2207; and if the data management unit 311, 324 determines that the data is not re-accessed, the processing proceeds to S2208.

In S2207, the data management unit 311 updates the retention period (TTL) of the re-accessed data. More specifically, the data management unit 311 calculates a new TTL=the remaining TTL+a default TTL.

In S2208, the data management unit 311, 324 updates the retention label of the data, which is not re-accessed before the expiration of the retention period, to a deletion label.

In S2209, the data management unit 311, 324 judges whether or not the data to which the deletion label is assigned is accessed by the application 321 within a specified amount of time (for example, 12 hours). If the data management unit 311, 324 determines that the data is accessed, the processing proceeds to S2210; and if the data management unit 311, 324 determines that the data is not accessed, the processing proceeds to S2211.

In S2210, the data management unit 311 updates the deletion label of the accessed data to the retention label. Incidentally, the data management unit 311 may set the retention period to the relevant data.

In S2211, the data management unit 311 issues an instruction to the deletion unit 325 to delete the data which has not been accessed by the application 321 within the specified amount of time, and data to which the same group label as that of the group label of the relevant data is assigned. The deletion unit 325 deletes the designated data from the storage apparatus 223.

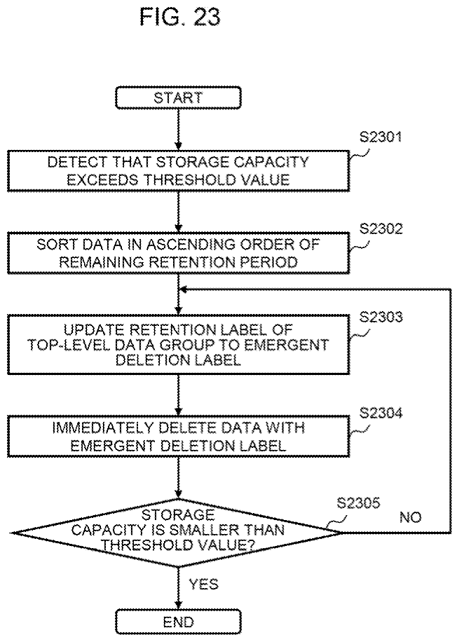

FIG. 23 is a diagram illustrating an example of the emergent deletion processing.

In S2301, the data management unit 324 detects an excess of the storage capacity beyond a threshold value. For example, the data management unit 324 transmits a volume name of a volume which exceeds the threshold value of the storage capacity (processing target volume) to the data management unit 311.

In S2302, the data management unit 311 sorts data of the processing target volume in ascending order of the remaining retention period (the remaining TTL).

In S2303, the data management unit 311 updates the retention label of data with the shortest remaining retention period (the remaining TTL) and data having the same group label as that assigned to the relevant data (top-level data group) to an emergent deletion label.

In S2304, the data management unit 311 issues an instruction to the deletion unit 325 to immediately delete the data to which the emergent deletion label is assigned. The deletion unit 325 deletes the designated data.

In S2305, the data management unit 324 judges whether the storage capacity of the processing target volume is smaller than a threshold value or not. If the data management unit 324 determines that the storage capacity is smaller than the threshold value, it terminates the processing; and if the data management unit 324 determines that the storage capacity is not smaller than the threshold value, the processing proceeds to S2303.

The application(s) and the data can be optimally deployed in the edge servers according to this embodiment.

### (2) Additional Description

The aforementioned embodiment includes, for example, the following content.

The aforementioned embodiment has described the case where the present invention is applied to the operation management system; however, the present invention is not limited to this example and can be applied to a wide variety of other systems, apparatuses, methods, programs, and storage media which store such programs.

Moreover, the aforementioned embodiment has described the case where the processing labels of data are managed by the operation management server 110, but the invention is not limited to this example. For example, the processing label may be assigned to data in the storage apparatus 223 and the processing label of the data may be managed by the edge server 120.

Moreover, the aforementioned embodiment has been described so that the analysis unit 312 sorts the candidates in the server list, on the basis of whether they have the operation results of the migration target application 321 or not; however, the invention is not limited to this example. For example, the analysis unit 312 may delete a candidate for the edge server 120 which has no operation results of the migration target application 321, from the server list.

Moreover, in the aforementioned embodiment, the configuration of each table is one example and one table may be divided into two or more tables or all or part of two or more tables may be one table.

Moreover, in the aforementioned embodiment, various types of data have been explained by using the expression “XX table” for explanatory convenience; however, there is no imitation on the data structure and they may be expressed as, for example, “XX information.”

Moreover, the information of programs, tables, files, and so on for implementing the respective functions in the aforementioned explanation can be retained in a memory, storage devices such as hard drives or SSDs (Solid State Drives), or storage media such as IC cards, SD cards, or DVDs.

The aforementioned embodiment has, for example, the following characteristic configurations.

An operation management system (for example, the operation management system 100) includes a plurality of edge servers (for example, edge servers 120) and for managing operation of the plurality of edge servers, wherein the operation management system includes: a first edge server (for example, an edge server 120) including a first storage unit (for example, the storage apparatus 223, a volume) which stores data acquired from a sensor (for example, the sensor 130); a second edge server (for example, an edge server 120) including an application (for example, an application 321, a container, VM) for processing the data; an information management unit (for example, the data management unit 311, 324, the operation management server 110, a circuit) that generates relation information (for example, the relation information 111, the relation table 400), when the data stored in the first storage unit is processed by the application, by associating information indicating the data (for example, the data identifier 401), information indicating the first storage unit which stores the data (for example, the storage identifier 403, the retention place 404), information indicating the application (the application identifier 405), and information indicating the second edge server where the application is provided (the application operation location 407), with each other; and an output unit (for example, the data management unit 311, the operation management server 110, a circuit) that outputs the relation information generated by the information management unit.

The above-mentioned first edge server may be the same as, or different from, the above-mentioned second edge server. Outputs by the above-mentioned output unit may be displayed on a display, stored in the storage apparatus 223, transmitted to other computers, output as sounds by a speaker, printed on a paper medium or the like by a printer, projected onto a screen or the like by a projector, or implemented in other manners.

Since the relation information is output in the above-described configuration, it becomes possible to, for example, recognize the relationship between the application(s) and the data and manually or automatically deploy the application and/or the data in the optimum edge server(s).

The above-mentioned operation management system includes: a judgment unit (for example, the monitoring unit 322, an edge server 120, a circuit) that judges whether a load on resources provided in an edge server included by the above-mentioned operation management system exceeds a threshold value or not; and a deployment unit (for example, the deployment unit 323, an edge server 120, a circuit) that deploys a deployment target application which is provided in the edge server judged by the judgment unit that the load on its resources exceeds the threshold value (for example, which may be an application 321 with the largest required resource amount, an application 321 with the smallest I/O, or an arbitrary application 321), in an edge server different from the above-mentioned edge server.

Incidentally, if the application is deployed in another edge server and the load on resources provided in the other edge server exceeds the threshold value, the application will be deployed in a further another edge server which is different from the other edge server. Eventually, the application will be deployed in an edge server regarding which the resource load does not exceed the threshold value.

In the above-described configuration, the application of a specific edge server regarding which the resource load exceeds the threshold value is deployed in another edge server, so that it is possible to, for example, avoid the situation where the performance of the specific edge server will degrade.

The above-mentioned operation management system includes: a decision unit (for example, the analysis unit 312, the operation management server 110, a circuit) that decides, as a deployment destination of the above-mentioned application, an edge server whose free resource amount is larger than a required resource amount of the application, wherein the deployment unit deploys the application in the edge server.

In the above-described configuration, the deployment destination edge server is decided based on the free resource amount, so that, for example, the application of a specific edge server regarding which the load on the resources exceeds the threshold value can be deployed more appropriately.

The above-mentioned operation management system includes: a detection unit (for example, the monitoring unit 322, an edge server 120, a circuit) that detects a competition of resources included in the edge server judged by the judgment unit that the load on its resources exceeds the threshold value; and a decision unit (for example, the analysis unit 312, the operation management server 110, a circuit) that decides the deployment destination of the deployment target application provided in the edge server on the basis of a result detected by the detection unit, wherein when an occurrence of the competition of the resources is detected by the detection unit, the information management unit stores information indicating an application relating to the competition of the resources (for example, the resource competition occurrence 409); wherein the decision unit decides, as the deployment destination of the deployment target application, an edge server where an application regarding which the competition of the resources with the deployment target application has occurred is not provided (for example, see FIG. 12); and wherein the deployment unit deploys the deployment target application in the above-mentioned edge server.

In the above-described configuration, the edge server where the application regarding which the resource competition has occurred is not provided is decided as the application deployment destination, so that it is possible to, for example, avoid the situation where the resource load exceeds the threshold value immediately after the deployment of the application.

An application provided in the edge server included in the operation management system is a container; and wherein the operation management system includes a decision unit (for example, the analysis unit 312, the operation management server 110, a circuit) that decides an edge server where a container image for generating the container exists as a deployment destination of a deployment target container provided in the edge server judged by the judgment unit that the load on its resources exceeds the threshold value.

In the above-described configuration, the edge server including the container image of the relevant container is decided as the deployment destination of the container of the specific edge server regarding which the load on the resources exceeds the threshold value, so that it becomes possible to, for example, deploy the relevant container in a short time without the necessity for the relevant edge server to acquire the relevant container image.

The above-mentioned operation management system includes: a calculation unit (for example, the analysis unit 312, the operation management server 110, a circuit) that calculates a first access speed (for example, an access speed from the migration source) from a third edge server, which is judged by the judgment unit that the load on its resources exceeds the threshold value, to data used by a deployment target application provided in the third edge server, and a second access speed (for example, an access speed from the migration destination) from a fourth edge server, which is different from the third edge server, to the data; and a decision unit (for example, the analysis unit 312, the operation management server 110, a circuit) that decides the fourth edge server as a deployment destination of the application; and, if the second access speed is slower than the first access speed, decides an edge server including a storage unit which has a free space larger than a capacity of the data and makes an access speed from the fourth edge server to the data fastest, as a deployment destination of the data.

In the above-described configuration, if the access speed to the data becomes slower due to the redeployment of the application, the storage unit which stores the relevant data is redeployed. So, for example, if the resource load exceeds the threshold value, the application and the data can be deployed respectively in appropriate edge servers.

when a series of processing is terminated by the application provided in the edge server included by the operation management system, the information management unit assigns information indicating the same group (for example, a group label) to data used for the series of processing (for example, see FIG. 22).

In the above-described configuration, the same group label is assigned to the data used in the series of processing of the application, so that, for example, the data can be deployed on a group basis and the data can be accessed more efficiently in the processing by the application.

The above-mentioned operation management system includes: a judgment unit (for example, the monitoring unit 322, an edge server 120, a circuit) that judges whether an I/O (Input/Output) load on an edge server included by the operation management system exceeds a threshold value or not and a deployment unit (for example, the deployment unit 323, an edge server 120, a circuit) that deploys deployment target data, which is stored in the edge server judged by the judgment unit that the I/O load exceeds the threshold value, in an edge server different from the above-mentioned edge server.

In the above-described configuration, the data of a specific edge server regarding which the I/O load exceeds the threshold value is deployed in another edge server, so that it is possible to, for example, avoid the situation where the performance of the specific edge server will degrade.

The above-mentioned operation management system includes a decision unit (for example, the analysis unit 312, the operation management server 110, a circuit) that decides, as a deployment destination of the data, an edge server whose free resource amount is larger than a capacity of the data, wherein the deployment unit deploys the data in the above-mentioned edge server.

In the above-described configuration, the deployment destination edge server is decided based on the free space of the storage unit, so that, for example, the data of a specific edge server regarding which the I/O load exceeds the threshold value can be deployed more appropriately.

The above-mentioned operation management system includes: a detection unit (for example, the monitoring unit 322, an edge server 120, a circuit) that detects the I/O competition in the edge server judged by the judgment unit that the I/O load exceeds the threshold value; and a decision unit (for example, the analysis unit 312, the operation management server 110, a circuit) that decides a deployment destination of the deployment target data provided in the edge server on the basis of a result detected by the detection unit, wherein when an occurrence of the I/O competition is detected by the detection unit, the information management unit stores information indicating data relating to the I/O competition (for example, the I/O competition occurrence 410), wherein the decision unit decides, as the deployment destination of the deployment target data, an edge server that does not store data regarding which the I/O completion with the deployment target data has occurred (for example, see FIG. 19); and wherein the deployment unit deploys the deployment target data in the above-mentioned edge server.

In the above-described configuration, the edge server that does not store the data regarding which the I/O competition has occurred is decided as the deployment destination of the deployment target data, so that it is possible to, for example, avoid the situation where the I/O load exceeds the threshold value immediately after the deployment of the deployment target data.

The above-mentioned operation management system includes a decision unit (for example, the analysis unit 312, the operation management server 110, a circuit) that decides, as a deployment destination of the deployment target data stored in the edge server judged by the judgment unit that the I/O load exceeds the threshold value, an edge server for which time required to deploy the data is the shortest.

In the above-described configuration, the edge server which requires the shortest time to deploy the data of the specific edge server whose I/O load exceeds the threshold value is decided, so that, for example, the relevant data can be deployed in a short time.

The above-mentioned operation management system includes: a calculation unit (for example, the analysis unit 312, the operation management server 110, a circuit) that calculates a first access speed (for example, an access speed from the migration source) from a sixth edge server, in which an application using the deployment target data stored in a fifth edge server judged by the judgment unit that the I/O load exceeds the threshold value, to the data and a second access speed (for example, an access speed from the migration destination) from the sixth edge server to the data when the data is deployed in a seventh edge server; and a decision unit (for example, the analysis unit 312, the operation management server 110, a circuit) that: decides the seventh edge server as a deployment destination of the data; and, if the second access speed is slower than the first access speed, decides an edge server which makes an access speed to the data deployed in the seventh edge server fastest, as a deployment destination of the application.

In the above-described configuration, if the access speed to the data by the application becomes slower due to the redeployment of the data, the relevant application is redeployed. So, for example, if the I/O load exceeds the threshold value, the application and the data can be deployed respectively in appropriate edge servers.

The above-mentioned operation management system includes a deletion unit (for example, the deletion unit 325, an edge server 120, a circuit) that deletes data stored in an edge server included by the operation management system, wherein when data is processed by an application provided in the edge server included by the operation management system, the information management unit sets information indicating a retention period for retaining the data (for example, the retention period 412) with respect to the data; and wherein the deletion unit deletes the data regarding which the period set by the information management unit has elapsed (for example, see FIG. 22).

In the above-described configuration, the period for retaining the data is set, so that, for example, the data regarding which the relevant period has elapsed can be automatically deleted as unnecessary data.

If the free space of the storage unit of the edge server included in the above-mentioned operation management system becomes smaller than the first threshold value, the above-mentioned deletion unit deletes the data sequentially from the data with a short retention period in ascending order of the retention period until the free space of the above-mentioned storage unit becomes larger than the second threshold value (for example, see FIG. 23).

In the above-described configuration, if the free space of the storage unit becomes small, the data is deleted sequentially in ascending order of the retention period by starting from the data with the short retention period. So, for example, it is possible to avoid an error which occurs due to shortage of the capacity of the storage unit.

Moreover, the aforementioned configurations may be changed, rearranged, combined, and/or omitted as appropriate within the scope not departing from the gist of the present invention.

### REFERENCE SIGNS LIST

100: operation management system
110: operation management apparatus
120: edge server
130: sensor

1. An operation management system comprising a plurality of edge servers and for managing operation of the plurality of edge servers,
the operation management system comprising:
a first edge server including a first storage unit which stores data acquired from a sensor,
a second edge server including an application for processing the data;
an information management unit that generates relation information, when the data stored in the first storage unit is processed by the application, by associating information indicating the data, information indicating the first storage unit which stores the data, information indicating the application, and information indicating the second edge server in which the application is provided, with each other; and
an output unit that outputs the relation information generated by the information management unit.

2. The operation management system according to claim 1, comprising:
a judgment unit that judges whether a load on resources provided in an edge server included by the operation management system exceeds a threshold value or not; and
a deployment unit that deploys a deployment target application, which is provided in the edge server judged by the judgment unit that the load on its resources exceeds the threshold value, in an edge server different from the above-mentioned edge server.

3. The operation management system according to claim 2,
comprising a decision unit that decides, as a deployment destination of the application, an edge server whose free resource amount is larger than a required resource amount of the application,
wherein the deployment unit deploys the application in the edge server.

4. The operation management system according to claim 2, comprising:
a detection unit that detects a competition of resources included in the edge server judged by the judgment unit that the load on its resources exceeds the threshold value; and
a decision unit that decides the deployment destination of the deployment target application provided in the edge server on the basis of a result detected by the detection unit,
wherein when an occurrence of the competition of the resources is detected by the detection unit, the information management unit stores information indicating an application relating to the competition of the resources;
wherein the decision unit decides, as the deployment destination of the deployment target application, an edge server where an application regarding which the competition of the resources with the deployment target application has occurred is not provided; and
wherein the deployment unit deploys the deployment target application in the above-mentioned edge server.

5. The operation management system according to claim 2,
wherein an application provided in the edge server included in the operation management system is a container; and
wherein the operation management system comprises a decision unit that decides an edge server where a container image for generating the container exists as a deployment destination of a deployment target container provided in the edge server judged by the judgment unit that the load on its resources exceeds the threshold value.

6. The operation management system according to claim 2, comprising:
a calculation unit that calculates a first access speed from a third edge server, which is judged by the judgment unit that the load on its resources exceeds the threshold value, to data used by a deployment target application provided in the third edge server, and a second access speed from a fourth edge server, which is different from the third edge server, to the data; and
a decision unit that: decides the fourth edge server as a deployment destination of the application; and, if the second access speed is slower than the first access speed, decides an edge server including a storage unit which has a free space larger than a capacity of the data and makes an access speed from the fourth edge server to the data fastest, as a deployment destination of the data.

7. The operation management system according to claim 6,
wherein when a series of processing is terminated by the application provided in the edge server included by the operation management system, the information management unit assigns information indicating the same group to data used for the series of processing.

8. The operation management system according to claim 1, comprising:
a judgment unit that judges whether an I/O (Input/Output) load on an edge server included by the operation management system exceeds a threshold value or not; and
a deployment unit that deploys deployment target data, which is stored in the edge server judged by the judgment unit that the I/O load exceeds the threshold value, in an edge server different from the above-mentioned edge server.

9. The operation management system according to claim 8,
comprising a decision unit that decides, as a deployment destination of the data, an edge server whose free resource amount is larger than a capacity of the data,
wherein the deployment unit deploys the data in the edge server.

10. The operation management system according to claim 8, comprising:
a detection unit that detects the I/O competition in the edge server judged by the judgment unit that the I/O load exceeds the threshold value; and
a decision unit that decides a deployment destination of the deployment target data provided in the edge server on the basis of a result detected by the detection unit,
wherein when an occurrence of the I/O competition is detected by the detection unit, the information management unit stores information indicating data relating to the I/O competition;
wherein the decision unit decides, as the deployment destination of the deployment target data, an edge server that does not store data regarding which the I/O completion with the deployment target data has occurred; and
wherein the deployment unit deploys the deployment target data in the above-mentioned edge server.

11. The operation management system according to claim 8,
comprising a decision unit that decides, as a deployment destination of the deployment target data stored in the edge server judged by the judgment unit that the I/O load exceeds the threshold value, an edge server for which time required to deploy the data is the shortest.

12. The operation management system according to claim 8, comprising:
a calculation unit that calculates a first access speed from a sixth edge server, in which an application using the deployment target data stored in a fifth edge server judged by the judgment unit that the I/O load exceeds the threshold value, to the data, and a second access speed from the sixth edge server to the data when the data is deployed in a seventh edge server; and
a decision unit that: decides the seventh edge server as a deployment destination of the data; and, if the second access speed is slower than the first access speed, decides an edge server which makes an access speed to the data deployed in the seventh edge server fastest, as a deployment destination of the application.

13. The operation management system according to claim 1,
comprising a deletion unit that deletes data stored in an edge server included by the operation management system,
wherein when data is processed by an application provided in the edge server included by the operation management system, the information management unit sets information indicating a retention period for retaining the data with respect to the data; and
wherein the deletion unit deletes the data regarding which the period set by the information management unit has elapsed.

14. The operation management system according to claim 13,
wherein when a free space of a storage unit for the edge server included by the operation management system becomes smaller than a first threshold value, the deletion unit deletes the data sequentially in ascending order of the length of a retention period by starting from the data with a short retention period until the free space of the storage unit becomes larger than a second threshold value.

15. An operation management method for an operation management system including a plurality of edge servers and for managing operation of the plurality of edge servers,
the operation management system including:
a first edge server including a first storage unit which stores data acquired from a sensor; and
a second edge server including an application for processing the data, and
the operation management method comprising:
a step executed by an information management unit generating relation information, when the data stored in the first storage unit is processed by the application, by associating information indicating the data, information indicating the first storage unit which stores the data, information indicating the application, and information indicating the second edge server in which the application is provided, with each other; and
a step executed by an output unit outputting the relation information generated by the information management unit.
